(19) United States
(12) Patent Application Publication
(10) Pub. No.: US 2011/0099028 A1
(43) Pub. Date: Apr. 28, 2011

(54) SYSTEMS AND METHODS FOR VERIFYING MEDICAL PROGRAM ELIGIBILITY AND PAYMENT DATA

(76) Inventors: Larry van der Veen, San Carlos, CA (US); Paul Spaeth, Half Moon Bay, CA (US); Charles Marshall, Atherton, CA (US)

(21) Appl. No.: 12/911,918

(22) Filed: Oct. 26, 2010

Related U.S. Application Data
(60) Provisional application No. 61/255,307, filed on Oct. 27, 2009.

(51) Int. Cl. G06Q 50/00; G06Q 20/00

(52) U.S. Cl. 705/2; 705/1.1; 705/39; 705/44

(57) ABSTRACT

Systems, methods and means for facilitating verification transactions in connection with a discount medical program are provided which include a verification host, configured to maintain rules and logic relating to price and member verification, a rate verification subsystem configured to maintain rules and logic for receiving price information from a plurality of discount medical plan sponsors including the prices for services from each medical service provider participating in the program and for processing requests for price verification received from medical services providers, and a member verification subsystem configured to maintain rules and logic for issuing a payment card to individuals with said card representing membership in a discount medical program, for receiving member information from medical plan sponsors including the current membership status of each member, for processing requests for member verification received from medical services providers, and for processing payment transactions associated with the member payment card.

### CROSS-REFERENCE TO RELATED APPLICATION

This Application claims the benefit of and priority to U.S. Provisional Patent Application Ser. No. 61/255,307, filed Oct. 27, 2009, which is incorporated herein by reference for all purposes.

### BACKGROUND

The present invention generally relates to discount medical plans and payment systems and, more particularly, to a system and method for verifying eligibility and payment information of a discount medical program using a payment card.

The healthcare industry is undergoing rapid transformation. In 2007, healthcare expenditures in the U.S. were estimated to be $2.4 trillion and represented approximately 16% of the country's gross domestic product. The US Department of Health and Human Services projects that these expenditures will climb to $4.1 trillion and 19.6% of GDP by 2016. One of the most dramatic changes occurring in the industry is the steady rise in the financial responsibility that individuals and consumers must bear in paying for their own or their family's health care. Employers, government agencies and other sponsors of health care coverage are increasingly shifting the burden of paying for escalating health care costs towards individual beneficiaries by raising premiums on health care insurance plans, increasing the level of deductibles or coinsurance that individuals must pay out of pocket or, in many cases, dropping health care coverage altogether.

A major response of individual consumers paying directly for their health coverage has been the development of a greater sensitivity to the prices they pay for medical products and services. In particular, consumers are becoming increasingly more value conscious in their attitude towards purchasing medical products and services and are more frequently seeking out medical care providers willing to offer discounts off of standard rates for services and procedures. A result of this growing level of consumer sensitivity to health care costs has been the expansion in the number of health plans and programs which offer their members access to medical providers who have contractually agreed to sell products and services at a discount to prices that they would otherwise charge to those who are not members of these programs.

One example of these programs includes Preferred Provider Organizations which are organized as a network of providers who offer reduced rates for services to health plan providers and their members. Another example is membership-based discount medical programs which contract with a defined set of medical providers for reduced rates on services and offer access to these contractually reduced fees and prices to their individual members. The members pay a program membership fee for the benefit of receiving these discounts on services from the program's network of providers, while the providers benefit from an ability to advertise or otherwise expose their services to a large base of program members.

The proliferation of programs and plans offering reductions in fees and rates on medical services has created confusion for medical providers who often belong to multiple discount plans, each with a separate schedule of prices and discounts on services. Moreover, providers may see many individuals during a day who belong to one of a variety of discount medical programs. Currently providers do not have a convenient way to verify the membership validity of an individual who professes to belong to a discount membership program. In some cases, the individual's membership may have expired or have been invalidated for reasons such as the non-payment of the membership fee. For each encounter with an individual who requests services from the provider under a discount medical program the provider must therefore verify that the provider is a member of the plan's network of providers, the contracted rates for which the provider is obligated to provide services under the plan, and the membership status of the individual requesting the discounted rates on services.

Today most programs provide a membership card to their members as evidence of membership in a discount medical program. The program rules require that the card be presented by the member at the time of an encounter with a medical services provider in order for the member to receive the discounted rates or prices on the provider's services. When obtaining care, the provider must confirm that the cardholder is in good standing with the plan and is eligible to receive care under at a contracted rate established under a plan. To perform these functions, the provider must separately consult numerous plan documents or a rate verification service to confirm the provider's participation in the plan and the contracted prices for services. In addition, the provider must separately contact the plan sponsor and provide the membership name or number from the membership card in order to confirm that the cardholder's membership status in the plan is current and valid. It is easy to see that performing these tasks is cumbersome, costly and time-consuming for providers and their staff. It is therefore desirable to overcome the problems associated with this process by providing more efficient and less costly methods and systems for verifying provider participation, contracted plan rates and individual membership status associated with discount medical programs.

### BRIEF SUMMARY

A method and system is disclosed for using a payment card for facilitating the verification of the participation status and contract rates of providers and individuals participating in a discount medical program. A combined membership and payment card is issued to members by the discount medical program plan. The plan contract with medical service providers for discounted or reduced rates on services and with members who are offered access to these contractually discount services for a fee. The payment card serves as evidence of membership in the discount medical program and is linked to a transaction account such as a checking, credit or stored value account. The payment card account number is associated with the discount medical plan account number so that the card can be used for both accessing the program membership status of the card owner and for performing payment transactions such as purchases, cash withdrawals or bill payments. The card bears contact information which can be used by providers to contact a verification system for verifying the provider's participation in the discount medical program, the contracted rates for services under the program and the membership status of the cardholder. In addition, the card may be debited for a verification fee in circumstances in which the program rules allow such a fee to be assessed.

Plan sponsors submit discount medical program, provider and member card profile data to the verification system on a periodic basis, such as each time there are changes to the provider network, the contract rates, the program membership or the status of providers or members in the program. Alternatively, the profile information is provided or updated on a regularly scheduled basis as, for example, daily or weekly.

Program members who seek the services of program providers present the payment card to request the contract rates associated with the program. The program provider contacts the verification system using the contact information on the payment card. This contact information may be a URL or other electronic interface to access a host computer. The program provider submits a provider identification number, the service codes associated with the services for which the provider is seeking verification and the membership card number. The price verification subsystem of the verification system compares the provider number and the card account number to the provider profile data maintained by the subsystem. The card account number identifies the member plan. The provider participation in the plan is verified and the rates associated with the provider's contract with the plan for the service codes requested are determined from the provider profile information. In addition a member verification subsystem verifies the status of the membership by comparing the payment card account number against a list of valid membership account numbers affiliated with the program from the member profile information. The verification system then transmits a response to the program provider wherein the response includes a verification of the membership status of the member and the contracted rates for services. In an exemplary embodiment the member verification subsystem debits the account of the cardholder for a contract verification fee and transmits as part of the verification response the remaining balance in the member account.

### BRIEF DESCRIPTION OF THE DRAWINGS

FIG. 1 schematically illustrates an overview of an exemplary process flow according to one embodiment of the present invention.

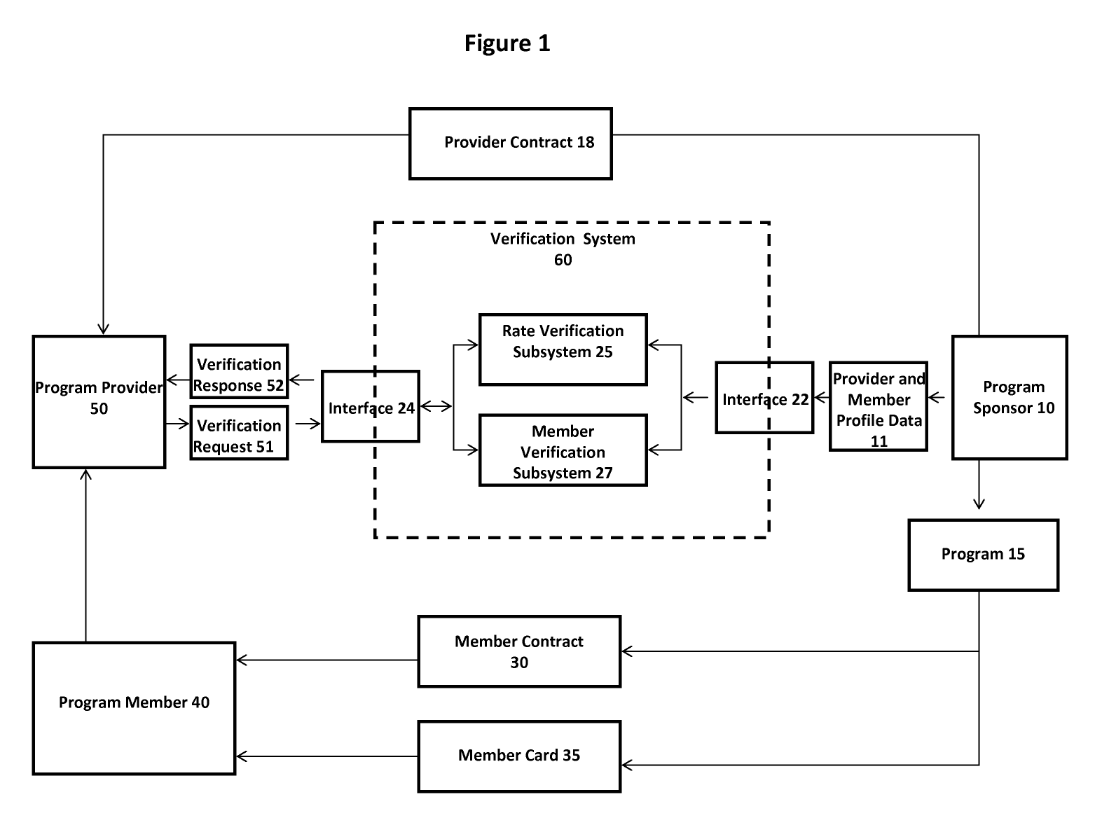

FIG. 2 illustrates the data elements contained in a program provider contract according to one embodiment of the present invention.

FIG. 3 illustrates the data elements provided by discount medical program sponsors to a verification system according to one embodiment of the present invention.

FIG. 4 is a flow diagram illustrating one embodiment of a method for verifying the contract rates of program providers and the membership status of program members affiliated with a discount medical plan and transmitting the membership status and program provider contract rates to program providers.

FIG. 5 is a flow diagram illustrating one embodiment of a method for verifying the contract rates of program providers and the membership status of program members affiliated with a discount medical plan, debiting the account of program members for a verification fee and transmitting the membership status and program provider contract rates to program providers.

FIG. 6 is a flow diagram illustrating one embodiment of a method for verifying the contract rates of program providers and the membership status of program members affiliated with a discount medical plan, debiting the account of program members for a verification fee and transmitting the membership status, member account balance and program provider contract rates to program providers.

### DETAILED DESCRIPTION

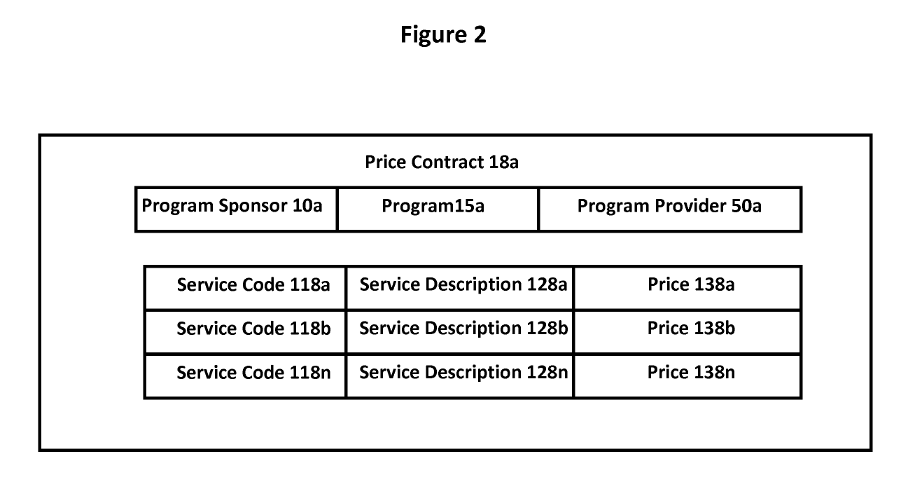

A discount medical plan sponsor 10 creates at least one discount medical program 15 for medical services and establishes at least one contract 18 with at least one program provider 50 wherein the program provider 50 agrees to provide services at specified prices to program members 40. An example is a physician group or a preferred provider organization (PPO) that agrees to offer a defined set of outpatient services to the health plan at a fixed proportion of Medicare reimbursement rates. In exemplary embodiments, the rates for services charged by program providers would be at a discount to their standard rates for such services. Another example is a discount medical program in which medical providers offer discounts off of standard prices and fees to plan members in exchange for the opportunity to attract a large group of program members to their services. In an embodiment, illustrated in FIG. 2, program provider contract 18a may include a price schedule which, for example, identifies the program sponsor 10a, a program identifier 15a, the program provider 50a, the service codes 118a-118n and service descriptions 128a-128n included in the contract 18a and the fees, prices, rates or discounts 138a-138n associated with each of those services. Other embodiments may include programs with specified discount rates applied to a specified set of services. Practitioners skilled in the art will recognize other variations of contract discount arrangements which can be implemented between medical plans and service providers under the present invention. It should be understood that in the context of this invention services provided by medical service providers 50 may include either products or services or a combination of products and services.

In various embodiments, program providers 50 may include physicians, clinics, medical groups, hospitals, pharmacies, medical supply companies, retailers selling health care products and services, physical therapists, dentists, chiropractors, or vision care specialists. Some of the programs established by program sponsor 10 may include group health plans, individual health plans or discount medical plans and may include contracted prices for physician services, clinical services, hospital care, dental care, vision care, chiropractic care, medical supplies, pharmaceuticals, prescription drugs, over the counter drugs, physical therapy or other health care services as may be provided by program providers 50.

Program members 40 who belong to program 15 have agreed to a contract of membership 30 and are issued a program membership card 35. The contract of membership 30 evidences that program member 40 agrees to the terms and conditions of plan membership. In various embodiments some of these terms and conditions may include a set of services available to program members, the set of program providers who have contracted to offer services to program members at a discount, the level of prices or rates at which program members may receive services from program providers, the benefits provided to the program member under the plan and the fees and costs to be borne by the program member for receiving the benefits of medical plan. In one embodiment, program 15 includes a contract verification fee which is assessed to members 40 and debited to card 35 for each encounter with a program provider 50 wherein the program provider requests verification of the contract rates and membership status of program members 40 in the program 15.

Membership card 35 functions both as an indicator of membership in program 15 and as a payment card linked to a stored value, credit, debit or other form of transaction account. In various embodiments the membership card 35 may be operable on national and international payment networks such as Visa, Discover, American Express, MasterCard, Plus, Cirrus, Maestro, Interlink, NYCE or STAR or on a closed loop or proprietary payment network maintained for purposes of supporting an embodiment of the present invention. In one embodiment card 35 is issued by the program sponsor 10. In one embodiment, card 35 is issued by a third party who is unaffiliated with the program sponsor 10, such as a financial institution or a payment card processor. Membership card account processing could be an operation that is internal to the card issuer or it could be an external operation carried out by an agent

In one embodiment, the membership card number of card 35 and the account number of program 15 are identical. For example, a discount medical program established by a program sponsor may assign the same account number to the member for purposes of identifying the member as associated with an individual discount program and to a payment card for purposes of verifying the member's affiliation with a plan and for making purchases or cash withdrawals. Optionally, the account number of card 35 and the membership number of program 15 assigned to program member 40 need not be identical, but can be linked in a data structure that associates the card account number with the program account number.

Contact information is displayed on membership card 35, being a means by which program providers may contact a verification service to verify the membership status of the program member, the participation status of the program provider, the contract prices for services under program 15, or a combination of these activities. In various embodiments, the contact information displayed on the card is an electronic interface such as for example a URL, a web services interface other digital identifier used for establishing contact with a host computer. Contact information may be displayed on either the front or the back of the card.

Verification system 60 maintains the computers, logic, applications, networks, interfaces, information and data necessary to respond to requests from program providers for verification of program provider 50 participation in program 15, contract 18 rates and program member 40 membership status in program 15 and for performing card 35 payment account processing. Verification system 60 comprises a price verification subsystem 25 and a member verification subsystem 27.

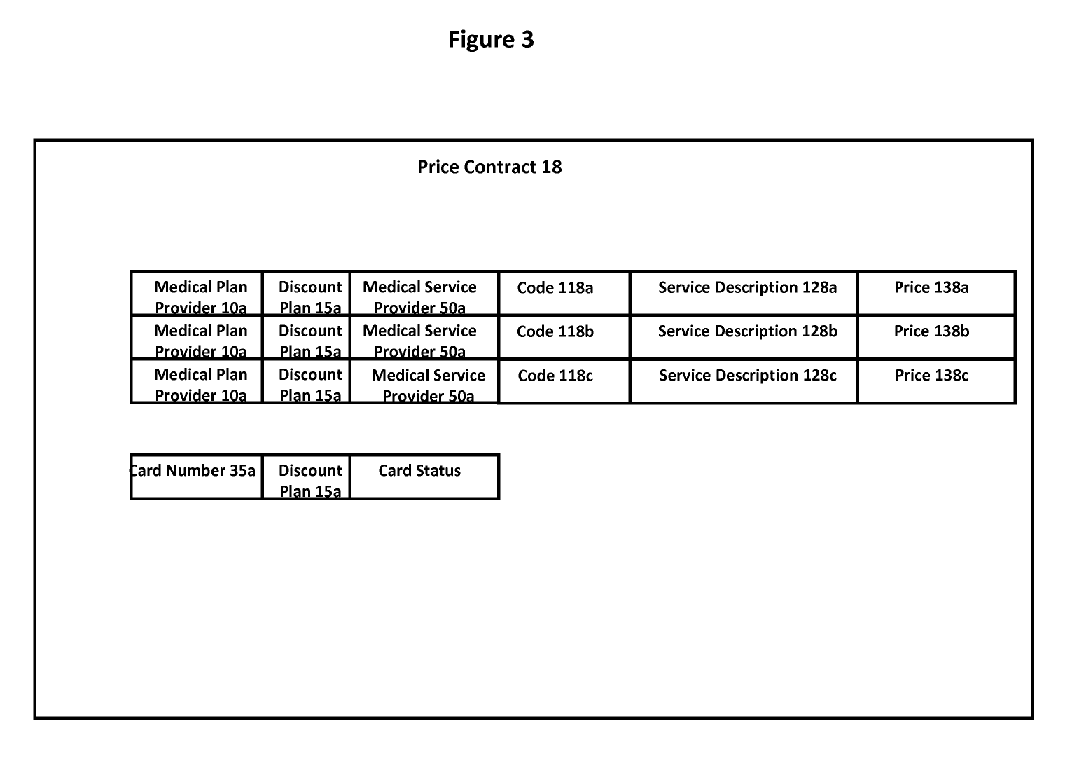

Program sponsors 10 communicate with verification system 60 using an interface 22. In various embodiments interface 22 may be a voice response unit, website, ftp host computer, etc. Program sponsors supply verification system 60 with profile information related to the program provider contracts and rates and the program member 40 membership and card status. The program member 40 and contract 18 profile information transmitted by program sponsor 10 to verification system 60 includes, in a preferred embodiment, the contract rates for services associated with each medical provider under each medical plan sponsored by the medical plan provider and the card numbers and membership status of each member of programs sponsored by the program sponsors. FIG. 3 is an example of data elements that may be included by program sponsors in updating the contract and membership profiles of verification system 60.

Program providers 50 communicate with verification system 60 using an interface 24. Interface 24 functions to receive requests for verification services from program providers, communicate and coordinate requests to a verification system 60 and transmit verification responses back to the requesting program providers. In various embodiments, interface 24 may be implemented as a voice response unit, a web server, an FTP server etc.

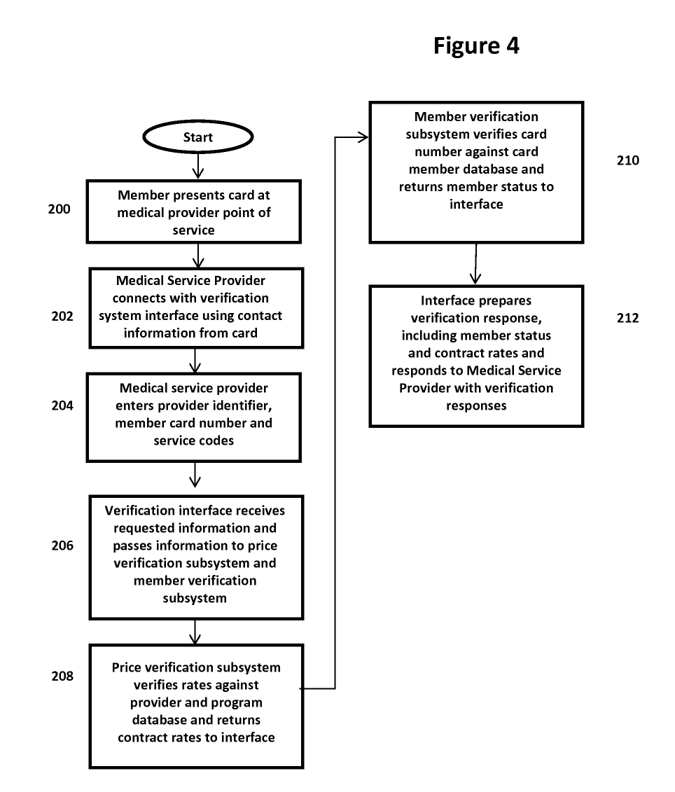

FIG. 4 is a flow diagram illustrating one embodiment of a method for verifying the contract rates of program providers and the membership status of program members affiliated with a discount medical program and transmitting the membership status and program provider contract rates to program providers. At step 200 program members 40 who seek or receive services from program providers 50 present a member card 35 in order to receive the contracted prices 18 on services eligible under program 15. To verify the participation status of program provider 50 in program 15, the contracted prices 18 and the validity of the status of program member 40 in program 15, at step 202 program provider 50 initiates a communication with verification system 60 using interface 24 and at step 204 enters a provider identifier, the service descriptor codes for which prices are requested and the program member card number. The program provider identifier is a number or code assigned to the program provider for purposes of uniquely identifying the provider and in some embodiments may be a tax identification number, a National Provider Identifier (NPI), or a User ID and PIN. Service descriptor codes may be, for example, CPT, ICD 9, or HCPC codes as established by national standards bodies. At step 206 interface 24 communicates the information from the program provider to price verification subsystem 25 and a member verification subsystem 27.

Price verification subsystem 25 maintains the rules, applications, logic, and program provider profile information necessary for determining the rates applicable to plan 15 and program provider 50. In an exemplary embodiment, the program provider profile includes such things as the program provider name, program provider number, the programs in which the program provider participates and the prices or rates for each service which the program provider has contractually established with each program. At step 208 price verification subsystem 25 determines the contract rates corresponding to program provider identifier 50 by associating the service descriptors, provider number and the member card number with data from the program provider profile. In an exemplary embodiment, subsystem 25 then returns a verification response to interface 24 comprising such things for example as the program provider number, service descriptors and medical plan number corresponding to the verification request of program provider 50 and the contract rates associated with each service.

Member verification subsystem 27 maintains the rules, applications, logic and member profile information necessary for determining the membership status of the card 35 account number associated with program 15. In an exemplary embodiment, member profile information includes the program member name, address, card number, card expiration date, card security code, card status current card balance available for spending and the medical plan number associated with the card number. Card status may include indicators which identify, for example, if the card is active or inactive and if the card is valid for receiving discounted services under a discount medical program. At 210 member verification subsystem 27 determines the membership status of member 40 by verifying the member card number against a list of valid card member numbers. Member verification subsystem 27 then transmits the program membership status to interface 24 comprising such things as the card number and a code which indicates if the member is approved for receiving for receiving services at contract rates associated with program 15. At 212 interface 24 prepares a verification response comprising for example the program member status, the program provider contract rates, the program member number and the program provider number. Interface 24 then transmits the verification response to the program provider 50.

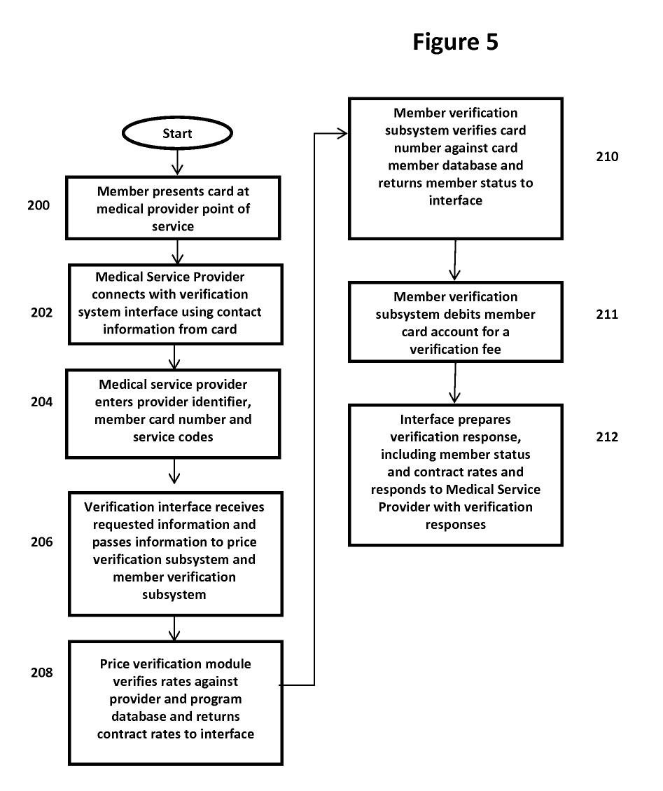

FIG. 5 is a flow diagram illustrating one embodiment of a method for verifying the contract rates of program providers and the membership status of program members affiliated with a discount medical program, debiting the account of program members for a verification fee and transmitting the membership status and program provider contract rates to program providers. Specifically, at 211 in addition to determining the member status of the program member, the member verification subsystem 27 debits the member payment account for a verification fee. Accordingly, other than steps 211, all of the steps of FIG. 5 remain the same as those described with reference to FIG. 4.

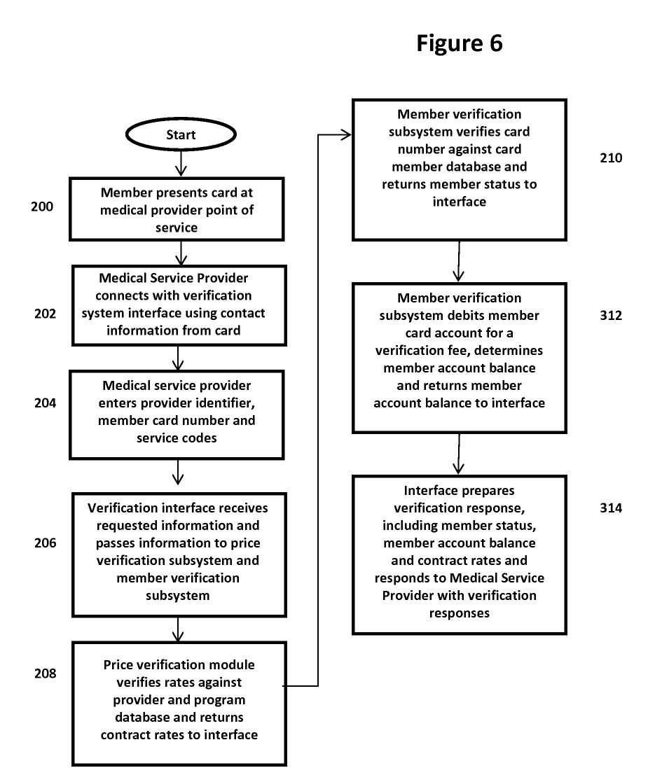

FIG. 6 is a flow diagram illustrating one embodiment of a method for verifying the contract rates of program providers and the membership status of program members affiliated with a discount medical plan, debiting the account of program members for a verification fee and transmitting the membership status, member account balance and program provider contract rates to program providers. Specifically, at 312 in addition to determining the member status of the program member, the member verification subsystem 27 debits the member payment account for a verification fee, determines the account balance of the program member account and transmits the program member account status and the program member account balance to interface 24. At 314 interface 24 prepares a verification response comprising for example the program member status, the program provider contract rates, the program member number and the program provider number and the program member account balance. Interface 24 then transmits the verification response to the program provider 50.

Accordingly, other than steps 312 and 314, all of the steps of FIG. 6 remain the same as those described with reference to FIG. 4.

We claim:

1. A system for facilitating verification transactions in connection with a discount medical program comprising:
a verification host, configured to maintain rules and logic relating to price and member verification;
a rate verification subsystem configured to maintain rules and logic for receiving price information from a plurality of discount medical plan sponsors including the prices for services from each medical service provider participating in the program and for processing requests for price verification received from medical services providers; and
a member verification subsystem configured to maintain rules and logic for issuing a payment card to individuals with said card representing membership in a discount medical program, for receiving member information from medical plan sponsors including the current membership status of each member, for processing requests for member verification received from medical services providers, and for processing payment transactions associated with the member payment card.

2. The system of claim 1 wherein the information provided by discount medical programs includes at least one program number corresponding to at least one discount medical program, the prices for services associated with said discount medical program, and at least one program member number corresponding to at least one individual participating in the discount medical program.

3. The system of claim 1 wherein the verification subsystem is configured to receive a price verification request from a plurality of medical service providers wherein the verification request includes at least a provider number, a member number and at least one service code and further configured to include a rate verification subsystem which maintains rules and logic for matching a medical service provider number and a service code to a discount medical program, retrieving the prices associated with said program, said code and said medical service provider and forwarding a verification response to said medical service provider and further includes a member verification subsystem which maintains rules and logic for matching the member number to a discount medical program, retrieving the member number associated with said program, verifying the eligibility of the member to receive the benefits associated with said program and forwarding a verification response to said medical service provider.

4. The system of claim 1 wherein the member payment card is configured to display contact information including a phone number, or an URL (etc) allowing a medical service provider to initiate communication with a verification system to verify the prices associated with the member's discount program and the eligibility of the member to receive benefits under the discount program.

5. The system of claim 1 wherein the member payment card is linked to a transaction account allowing the payment card to function as both evidence of membership in a discount medical program and for transacting purchases, cash withdrawals, bill payments etc.

6. The system of claim 1 wherein the member verification subsystem is configured to allow for each verification request the debiting of the payment card account for a verification fee.

7. The system of claim 1 wherein the member verification subsystem is configured to determine the current account balance of the payment card account and forward that balance to a medical service provider.

8. The system of claim 1 wherein the member status includes an indicator which identifies the member as at least one of the following: active, inactive, eligible, ineligible, approved, not approved.

9. The system of claim 1 wherein the verification system is configured to communicate with at least one discount medical plan sponsor.

10. The system of claim 1 wherein the verification system is configured to communicate with at least one medical services provider.

11. The system of claim 3 wherein the verification system is configured to receive the verification request using an IVR, a web server, etc.

12. The system of claim 3 wherein the verification system is configured to forward a verification response using an IVR, a web server, etc.

13. The system of claim 3 wherein the verification request includes a provider number, a member number and at least one service code.

14. The system of claim 3 wherein the verification response includes a provider number, a member number, a verification of member eligibility, and the price for at least one service associated with a service code.

15. A method for verifying the service pricing of medical providers and the membership status of individuals using a system having a price verification subsystem and a member verification subsystem, the method comprising:
receiving at a host computer information related to a discount medical plan from a discount medical program sponsor, said information including at least one discount medical program number, the account numbers of members participating in each discount medical program, the account numbers or the provider numbers of at least one medical service provider participating in said discount medical plan; at least one service code associated with a medical service included in the discount medical program; and the eligibility of the program member to receive benefits under the program;
issuing at least one member card linked to both a payment account and a discount medical program account that functions as both a token to evidence membership in a discount medical program and for transacting purchases, cash withdrawals etc. configuring the payment card to display contact information including at least one of: a phone number, a URL etc. wherein the contact information allows a medical service provider to initiate communication with a verification system and request verification of prices associated with the services of the medical service provider under a discount medical plan and the eligibility of the cardholder to receive benefits under a discount medical program
receiving at a host computer at least one request from at least one medical service provider for verification of prices and member eligibility associated with at least one discount medical service program, said request including at least one member account number, at least one medical service provider account number, and at least one service code.
directing the request to a price verification system that matches the medical service provider account number and the member account number to a discount medical program, matches the service code to a service associated with the discount medical program, and retrieves the price for said service;
directing the requests to a member verification system that matches the member account number to a discount medical program and retrieves the status of eligibility for discount medical program benefits associated with said member
debiting the payment account of the program member for a verification fee
retrieving the balance of the payment account
forwarding a verification response to the medical service provider, including the account number of the member, the provider number, the price for each service code, the member eligibility status, and the balance of the member payment account

16. A method, comprising:
receiving, at a medical provider point of service, a member account number;
transmitting said member account number and a medical provider identifier to a verification service;
receiving, from said verification service, a verification response including a status of said member and a set of contract rates; and
automatically updating a database associated with said medical provider point of service with said status of said member and said set of contract rates.

17. The method of claim 16, wherein said status of said member includes data identifying a pre-authorization amount.

18. The method of claim 16, wherein said verification response is provided in a format compatible with said database, said format including at least one of: an XML format, an HTML format, and a string delimited format.

19. A method, comprising:
receiving, from a merchant provider location, a verification request message, said verification request message including a member account number and a merchant identifier;
comparing said member account number with a database of member account numbers to identify a status of said member and a rate sheet associated with said member;
comparing said merchant identifier with said rate sheet to identify a set of contract rates; and
transmitting said status of said member and said set of contract rates to said merchant provider location.

20. The method of claim 19, further comprising:
verifying a payment account status associated with said member account number.

21. The method of claim 20, further comprising:
creating a pre-authorization hold on said payment account.

22. The method of claim 19, wherein said transmitting said status and said set of contract rates includes identifying a preferred format of said merchant provider, and transmitting said status and said set of contract rates to said merchant provider in said preferred format.
